(19) United States
(12) Patent Application Publication
(10) Pub. No.: US 2011/0012879 A1
(43) Pub. Date: Jan. 20, 2011

(54) DISPLAY DEVICE HAVING OPTICAL SENSORS

(76) Inventors: Masaki Uehata, Osaka (JP); Akinori Kubota, Osaka (JP); Akizumi Fujioka, Osaka (JP); Toshimitsu Gotoh, Osaka (JP)

Correspondence Address: BIRCH STEWART KOLASCH & BIRCH, PO BOX 747, FALLS CHURCH, VA, 22040-0747, US

(21) Appl. No.: 12/922,994

(22) PCT Filed: Mar. 12, 2009
(86) PCT No.: PCT/JP2009/054716

§ 371 Date: Sep. 16, 2010

(30) Foreign Application Priority Data
Apr. 10, 2008 (JP) 2008-102445

(51) Int. Cl. G09G 5/00

(52) U.S. Cl. 345/207

(57) ABSTRACT

A liquid crystal panel with built-in sensors 11 includes, in a pixel array 17, a plurality of pixels 1 and a plurality of optical sensors 2 which are arranged in a row direction and a column direction. The optical sensors 2 are provided to be associated with pixels 1 in every other row (e.g., to be associated with pixels 1 in even rows). A panel drive circuit 16 performs one-line inversion drive and reads signals based on the amounts of received light, from the optical sensors 2. Since the outputs from the optical sensors 2 change in the same direction due to the influence of display data, stripe noise resulting from the switching of the polarities of voltages written into pixel circuits 3 is prevented from occurring in an image generated based on the outputs from the optical sensors 2.

### TECHNICAL FIELD

The present invention relates to a display device and more particularly to a display device having a plurality of optical sensors provided in a display panel.

### BACKGROUND ART

In recent years, electronic devices that can be operated by touching a screen with a finger, a pen, etc., have proliferated. In addition, for a method of detecting a touch position on a display screen, a method is known in which a plurality of optical sensors are provided in a display panel and a shadow image which is created when a finger or the like approaches the screen is detected with use of the optical sensors. In the method of detecting a shadow image, when the illumination of outside light is low (the surroundings are dark), it becomes difficult to distinguish between a shadow image and a background in an image obtained by the optical sensors and accordingly a touch position may not be able to be detected properly. In view of this, for display devices including a backlight, a method is also known in which a reflection image which is created when backlight light hits a finger is detected with use of optical sensors.

In addition, by outputting an image as it is which is generated based on the outputs from the optical sensors (hereinafter, referred to as a “scanned image”), the display device can be used as an image input device. For example, when a liquid crystal panel provided with a plurality of optical sensors is used as a display of a mobile phone, by providing an image input instruction with a business card being held over the front surface of the liquid crystal panel, a business card image can be captured into the mobile phone through the liquid crystal panel.

For a display device having a plurality of optical sensors provided in a display panel, techniques such as those described below are conventionally known. Patent Document 1 describes a flat display device in which a display area is divided into a plurality of processing blocks, a plurality of optical sensors are provided to each processing block, the characteristics of the optical sensors in each processing block are measured and stored, and precharge signals based on the stored characteristics are supplied to the optical sensors. In addition, Patent Document 2 describes a display device that applies positive voltages and negative voltages to pixel electrodes in a switching manner and detects a state of contact with or proximity to a display surface, based on signals received by light-receiving elements which are arranged adjacent to pixel electrodes whose state is changed from a positive voltage application state to a negative voltage application state.

[Patent Document 1] Japanese Laid-Open Patent Publication No. 2007-102154

[Patent Document 2] Japanese Laid-Open Patent Publication No. 2007-47991

### DISCLOSURE OF THE INVENTION

### Problems to be Solved by the Invention

In display devices having optical sensors such as those described above, since a coupling capacitance occurs between a pixel circuit and an optical sensor provided in a display panel, a phenomenon in which a displayed image is superimposed on a scanned image occurs. Hence, the process of removing the superimposed displayed image from the scanned image is performed if necessary.

However, the level of superimposition of the displayed image is dependent upon the polarity of voltages written into the pixel circuits. Hence, in the display device having optical sensors, noise may occur in a scanned image due to the influence of the polarity of voltages written into the pixel circuits. For example, in a liquid crystal display device having optical sensors that performs one-line inversion drive, since the level of superimposition changes line by line, stripe noise with a width of one line occurs in a scanned image. FIG. 16 is a diagram showing an example of a scanned image containing stripe noise. The scanned image shown in FIG. 16 is obtained in a state in which the letter A is displayed, and includes a shadow image of a finger. In the scanned image, superimposition of the letter A and stripe noise occur.

The reason for the occurrence of stripe noise will be described with reference to FIG. 17. FIG. 17 is a circuit diagram showing a part of a liquid crystal panel. In FIG. 17, a pixel circuit 91 and an optical sensor 92 are arranged in a pixel array, and a sensor output amplifier 93 is provided external to the pixel array. Since the pixel circuit 91 and the optical sensor 92 are arranged in proximity to each other in the pixel array, a coupling capacitance 90 occurs between a node X in the pixel circuit 91 (a connecting point between a TFT (Thin Film Transistor) 94 and a liquid crystal capacitance 95) and a node Y in the optical sensor 92 (a connecting point between a capacitor 96, a photodiode 97, and a sensor preamplifier 98).

When one-line inversion drive is performed, for example, a positive voltage is written into a node X in each of the pixel circuits 91 in odd rows, and a negative voltage is written into a node X in each of the pixel circuits 91 in even rows. Since a coupling capacitance 90 is present between the nodes X and Y, the voltage at the node Y increases when a positive voltage is written into the node X, and decreases when a negative voltage is written into the node X. Hence, the voltage at the node Y increases for those optical sensors 92 associated with the pixel circuits 91 in the odd rows, and decreases for those optical sensors 92 associated with the pixel circuits 91 in the even rows. In addition, the voltage at the node Y may decrease for those optical sensors 92 associated with the pixel circuits 91 in the odd rows, and increase for those optical sensors 92 associated with the pixel circuits 91 in the even rows. As such, since a row where the voltage at the node Y increases and a row where the voltage at the node Y decreases appear alternately in the pixel array, stripe noise with a width of one line occurs in a scanned image.

When a touch position is detected based on such a scanned image containing stripe noise, the detection accuracy for the touch position decreases. In addition, when an image is inputted with use of the display device, only such an image that contains noise can be inputted. The same phenomenon can also occur in a liquid crystal display device having optical sensors that performs dot inversion drive.

An object of the present invention is therefore to provide a display device that prevents noise resulting from the switching of the polarities of write voltages from occurring in a scanned image.

### Means for Solving the Problems

According to a first aspect of the present invention, there is provided a display device including a plurality of optical sensors, the display device including: a display panel including a plurality of pixels and a plurality of optical sensors which are arranged side by side in a row direction and in a column direction; and a drive circuit that performs an operation of writing voltages based on display data into pixel circuits in the respective pixels, and an operation of reading signals based on amounts of received light, from the optical sensors, wherein when the pixels are divided into a first group and a second group by arrangement position, all or most of the optical sensors are provided to be associated with pixels of the first group, and the drive circuit switches polarities of the voltages written into the pixel circuits between the pixels of the first group and the pixels of the second group, and reads the signals from the optical sensors associated with the pixels of the first group.

According to a second aspect of the present invention, in the first aspect of the present invention, when rows of the pixels are divided into first rows and second rows every predetermined number of rows according to arrangement order, all or most of the optical sensors are provided to be associated with pixels in the first rows, and the drive circuit switches the polarities of the voltages written into the pixel circuits between the pixels in the first rows and the pixels in the second rows, and reads the signals from the optical sensors associated with the pixels in the first rows.

According to a third aspect of the present invention, in the second aspect of the present invention, all or most of the optical sensors are provided to be associated with the pixels in every other row, and the drive circuit switches the polarities of the voltages written into the pixel circuits every row, and reads the signals from the optical sensors associated with the pixels in every other row.

According to a fourth aspect of the present invention, in the second aspect of the present invention, the optical sensors are provided to be associated with all of the pixels in the first rows.

According to a fifth aspect of the present invention, in the second aspect of the present invention, the optical sensors are provided to be associated with pixels with an interval of a predetermined number of pixels in the row direction, among the pixels in the first rows.

According to a sixth aspect of the present invention, in the second aspect of the present invention, all of the optical sensors are provided to be associated with the pixels in the first rows.

According to a seventh aspect of the present invention, in the first aspect of the present invention, when positions of the pixels are divided into first positions and second positions in a checkered pattern, all or most of the optical sensors are provided to be associated with pixels in the first positions, and the drive circuit switches the polarities of the voltages written into the pixel circuits between the pixels in the first positions and the pixels in the second positions, and reads the signals from the optical sensors associated with the pixels in the first positions.

According to an eighth aspect of the present invention, in the seventh aspect of the present invention, the optical sensors are provided to be associated with all of the pixels in the first positions.

According to a ninth aspect of the present invention, in the seventh aspect of the present invention, all of the optical sensors are provided to be associated with the pixels in the first positions.

According to a tenth aspect of the present invention, there is provided a method of driving a display device having a display panel including a plurality of pixels and a plurality of optical sensors which are arranged side by side in a row direction and in a column direction; and a drive circuit that drives the display panel, wherein, when the pixels are divided into a first group and a second group by arrangement position, all or most of the optical sensors are provided to be associated with pixels of the first group, the method including the steps of: by using the drive circuit, writing voltages based on display data into pixel circuits in the respective pixels while switching polarities of the voltages between the pixels of the first group and the pixels of the second group; and by using the drive circuit, reading signals based on amounts of received light, from the optical sensors associated with the pixels of the first group.

### Effect of the Invention

According to the first or tenth aspect of the present invention, voltages of the same polarity are written into pixel circuits in respective pixels of the first group, and signals are read from optical sensors associated with the pixels of the first group. Thus, the outputs from the optical sensors change in the same direction due to the influence of display data. Accordingly, noise resulting from the switching of the polarities of voltages written into the pixel circuits can be prevented from occurring in a scanned image generated based on the outputs from the optical sensors. Hence, a touch position can be detected with high accuracy based on a scanned image, and an image with suppressed noise can be inputted. In addition, by providing the optical sensors to be associated with some pixels, the amount of circuitry of the display device can be reduced.

According to the second aspect of the present invention, voltages of the same polarity are written into pixel circuits in respective pixels in the first rows, and signals are read from optical sensors associated with the pixels in the first rows. Thus, the outputs from the optical sensors change in the same direction due to the influence of display data. Accordingly, in a display device that performs line inversion drive in units of a predetermined number of lines, a scanned image can be obtained that does not contain stripe noise with a width of the predetermined number of lines which results from the switching of the polarities of write voltages.

According to the third aspect of the present invention, in a display device that performs one line inversion drive, a scanned image that does not contain stripe noise with a width of one line which results from the switching of the polarities of write voltages can be obtained.

According to the fourth aspect of the present invention, by providing optical sensors to be associated with all pixels in the rows of the first group, a scanned image whose number of pixels in the row direction is the same as that of the display panel and which does not contain stripe noise resulting from the switching of the polarities of write voltages can be obtained.

According to the fifth aspect of the present invention, by providing optical sensors to be associated with some pixels in the rows of the first group, the amount of circuitry of the display device can be reduced.

According to the sixth aspect of the present invention, by providing all optical sensors to be associated with pixels in the rows of the first group, a scanned image which is generated based on the outputs from all of the optical sensors and which does not contain stripe noise resulting from the switching of the polarities of write voltages can be obtained.

According to the seventh aspect of the present invention, voltages of the same polarity are written into pixel circuits in respective pixels in the first positions, and signals are read from optical sensors associated with the pixels in the first positions. Thus, the outputs from the optical sensors change in the same direction due to the influence of display data. Accordingly, in a display device that performs dot inversion drive, a scanned image that does not contain noise resulting from the switching of the polarities of write voltages can be obtained.

According to the eighth aspect of the present invention, by providing optical sensors to be associated with all pixels present in the same position as one of two colors of a checkered pattern, a scanned image whose number of pixels is half that of the display panel and which does not contain noise resulting from the switching of the polarities of write voltages can be obtained.

According to the ninth aspect of the present invention, by providing all optical sensors to be associated with pixels present in the same position as one of two colors of a checkered pattern, a scanned image which is generated based on the outputs from all of the optical sensors and which does not contain noise resulting from the switching of the polarities of write voltages can be obtained.

### BRIEF DESCRIPTION OF THE DRAWINGS

FIG. 1 is a block diagram showing a configuration of a liquid crystal display device according to a first embodiment of the present invention.

FIG. 2 is a block diagram showing a detailed configuration of a liquid crystal panel of the device shown in FIG. 1.

FIG. 3 is a diagram showing the arrangement position of optical sensors in the liquid crystal panel of the device shown in FIG. 1.

FIG. 4 is a diagram showing the operations of the device shown in FIG. 1.

FIG. 5 is a timing chart for the device shown in FIG. 1.

FIG. 6 is a diagram showing a cross section of the liquid crystal panel and the arrangement position of a backlight of the device shown in FIG. 1.

FIG. 7A is a diagram showing the principle of a method of detecting a shadow image in the device shown in FIG. 1.

FIG. 7B is a diagram showing the principle of a method of detecting a reflection image in the device shown in FIG. 1.

FIG. 8A is a diagram showing an example of a scanned image including a shadow image of a finger, which is obtained by the device shown in FIG. 1.

FIG. 8B is a diagram showing an example of another scanned image including a shadow image of a finger and a reflection image of the ball of the finger, which is obtained by the device shown in FIG. 1.

FIG. 9 is a diagram showing the arrangement position of optical sensors in a liquid crystal panel of a liquid crystal display device according to a variant of the first embodiment of the present invention.

FIG. 10 is a diagram showing a first example of the arrangement position of optical sensors in a liquid crystal panel of a liquid crystal display device according to a second embodiment of the present invention.

FIG. 11 is a diagram showing a second example of the arrangement position of the optical sensors in the liquid crystal panel of the liquid crystal display device according to the second embodiment of the present invention.

FIG. 12 is a diagram showing a third example of the arrangement position of the optical sensors in the liquid crystal panel of the liquid crystal display device according to the second embodiment of the present invention.

FIG. 13 is a diagram showing a fourth example of the arrangement position of the optical sensors in the liquid crystal panel of the liquid crystal display device according to the second embodiment of the present invention.

FIG. 14 is a diagram showing a fifth example of the arrangement position of the optical sensors in the liquid crystal panel of the liquid crystal display device according to the second embodiment of the present invention.

FIG. 15 is a diagram showing a sixth example of the arrangement position of the optical sensors in the liquid crystal panel of the liquid crystal display device according to the second embodiment of the present invention.

FIG. 16 is a diagram showing an example of a scanned image containing stripe noise.

FIG. 17 is a circuit diagram showing a part of a liquid crystal panel.

### DESCRIPTION OF THE REFERENCE NUMERALS

1 PIXEL
2 OPTICAL SENSOR
3 PIXEL CIRCUIT
10 LIQUID CRYSTAL DISPLAY DEVICE
11 LIQUID CRYSTAL PANEL WITH BUILT-IN SENSORS
12 DISPLAY DATA PROCESSING UNIT
13 A/D CONVERTER
14 SENSOR DATA PROCESSING UNIT
15 BACKLIGHT
16 PANEL DRIVE CIRCUIT
17, 18, and 61 to 66 PIXEL ARRAY
24 PHOTODIODE
51 OUTSIDE LIGHT
52 BACKLIGHT LIGHT
53 OBJECT

### BEST MODE FOR CARRYING OUT THE INVENTION

### First Embodiment

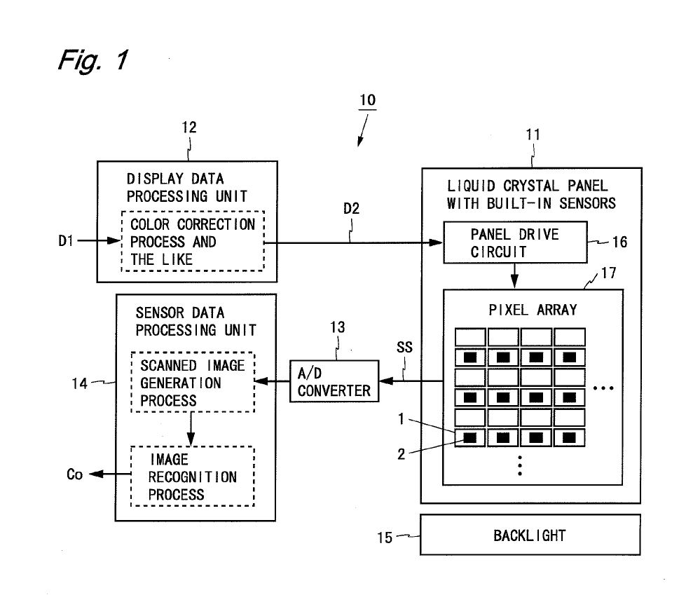

FIG. 1 is a block diagram showing a configuration of a liquid crystal display device according to a first embodiment of the present invention. A liquid crystal display device 10 shown in FIG. 1 includes a liquid crystal panel with built-in sensors 11, a display data processing unit 12, an A/D converter 13, a sensor data processing unit 14, and a backlight 15. The liquid crystal panel with built-in sensors 11 (hereinafter, referred to as the liquid crystal panel 11) includes a panel drive circuit 16 and a pixel array 17. The pixel array 17 includes a plurality of pixels 1 and a plurality of optical sensors 2 which are arranged two-dimensionally. Each pixel 1 includes three pixel circuits for red, green, and blue, respectively. Hereinafter, m is an even number greater than or equal to 2 and n is an integer greater than or equal to 2, and m/2 is denoted as s.

Display data D1 is inputted to the liquid crystal display device 10 from an external source. The display data processing unit 12 performs, if necessary, a color correction process, a frame rate conversion process, etc., on the display data D1 and outputs display data D2. The panel drive circuit 16 writes voltages based on the display data D2 into pixel circuits in the respective pixels 1 of the liquid crystal panel 11. By this, an image generated based on the display data D2 is displayed on the liquid crystal panel 11.

The backlight 15 irradiates light (backlight light) to a back surface of the liquid crystal panel 11, based on a power supply voltage supplied from a backlight power supply circuit (not shown). The backlight 15 is configured by, for example, white LEDs (Light Emitting Diodes). Note that the backlight 15 can employ any configuration and may be configured by a combination of red, green, and blue LEDs or by cold cathode fluorescent lamps (CCFLs).

The panel drive circuit 16 performs the operation of reading voltages based on the amounts of received light, from the respective optical sensors 2, in addition to the operation of writing voltages into the pixel circuits in the respective pixels 1. Output signals from the respective optical sensors 2 are outputted external to the liquid crystal panel 11, as sensor output signals SS. The A/D converter 13 converts the analog sensor output signals SS to digital signals. The sensor data processing unit 14 generates a digital image (scanned image), based on the digital signals outputted from the A/D converter 13. The scanned image may include an image of a matter to be detected (e.g., a finger, a pen, etc.; hereinafter, referred to as an object) which is present in the vicinity of a front surface of the liquid crystal panel 11. The sensor data processing unit 14 performs an image recognition process on the scanned image to detect an object and thereby determines an object position in the scanned image, and outputs coordinate data Co representing a touch position. Alternatively, the sensor data processing unit 14 may output the scanned image as it is, external to the liquid crystal display device 10.

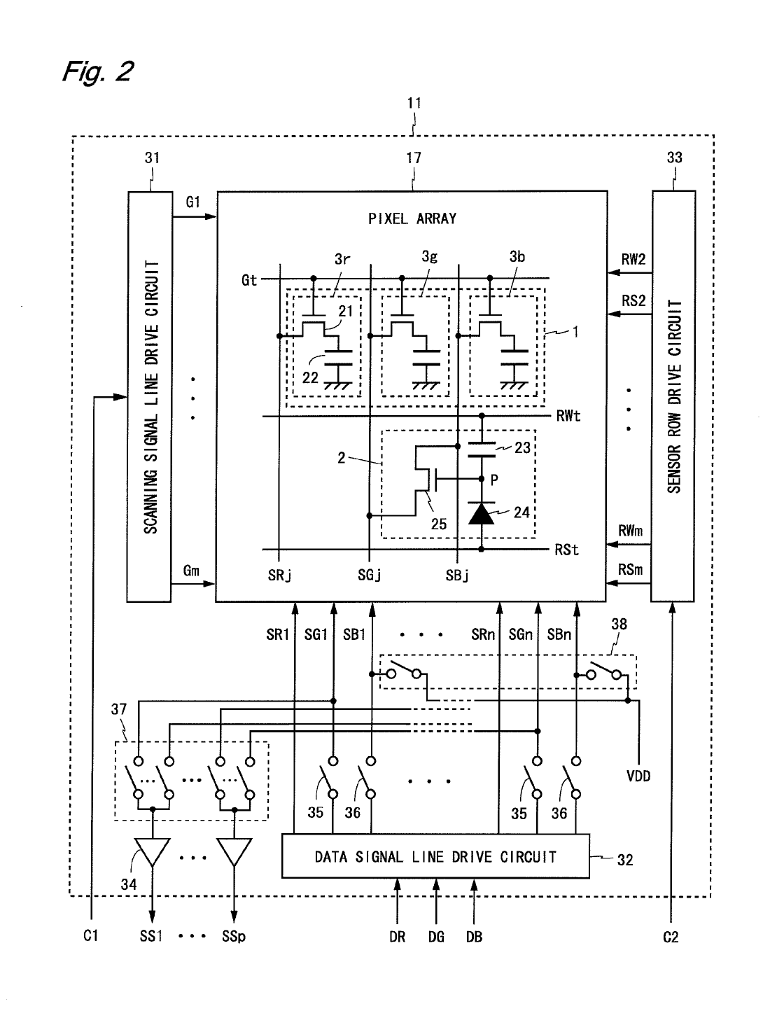

FIG. 2 is a block diagram showing a detailed configuration of the liquid crystal panel 11. As shown in FIG. 2, the pixel array 17 includes m scanning signal lines G1 to Gm; 3n data signal lines SR1 to SRn, SG1 to SGn, and SB1 to SBn; and (m×3n) pixel circuits 3. In addition to them, the pixel array 17 includes (s×n) optical sensors 2; s sensor read lines RWt (t is an even number between 2 and m inclusive); and s sensor reset lines RSt. The liquid crystal panel 11 is formed using polysilicon.

The scanning signal lines G1 to Gm are arranged parallel to one another. The data signal lines SR1 to SRn, SG1 to SGn, and SB1 to SBn are arranged parallel to one another so as to vertically intersect the scanning signal lines G1 to Gm. The sensor read lines RWt and the sensor reset lines RSt are arranged parallel to the scanning signal lines G1 to Gm.

The pixel circuits 3 are respectively provided near intersections of the scanning signal lines G1 to Gm and the data signal lines SR1 to SRn, SG1 to SGn, and SB1 to SBn. The pixel circuits 3 as a whole are arranged two-dimensionally such that m pixel circuits 3 are arranged in a column direction (a vertical direction in FIG. 2) and 3n pixel circuits 3 are arranged in a row direction (a horizontal direction in FIG. 2). The pixel circuits 3 are classified into R pixel circuits 3r, G pixel circuits 3g, and B pixel circuits 3b, depending on the color of a color filter provided. The three types of pixel circuits are arranged side by side in the row direction in the order of R, G, and B, and three pixel circuits form one pixel 1. As such, the liquid crystal panel 11 includes (m×n) pixels 1 arranged in the row and column directions.

Each pixel circuit 3 includes a TFT 21 and a liquid crystal capacitance 22. A gate terminal of the TFT 21 is connected to a corresponding scanning signal line Gi (i is an integer between 1 and m inclusive), a source terminal is connected to a corresponding one of the data signal lines SRj, SGj, and SBj (j is an integer between 1 and n inclusive), and a drain terminal is connected to one electrode of the liquid crystal capacitance 22. To the other electrode of the liquid crystal capacitance 22 is applied a common electrode voltage. The data signal lines SG1 to SGn connected to the G pixel circuits 3g are hereinafter referred to as the G data signal lines and the data signal lines SB1 to SBn connected to the B pixel circuits 3b as the B data signal lines. Note that each pixel circuit 3 may include an auxiliary capacitance.

The light transmittance of the pixel circuit 3 (the luminance of a sub-pixel) is determined by a voltage written into the pixel circuit 3. To write a certain voltage into a pixel circuit 3 connected to a scanning signal line Gi and a data signal line SXj (X is any one of R, G, and B), a high-level voltage (a voltage that places a TFT 21 in an on state) is applied to the scanning signal line Gi and a voltage to be written is applied to the data signal line SXj. By writing a voltage based on display data D2 into the pixel circuit 3, the luminance of the sub-pixel can be set to a desired level.

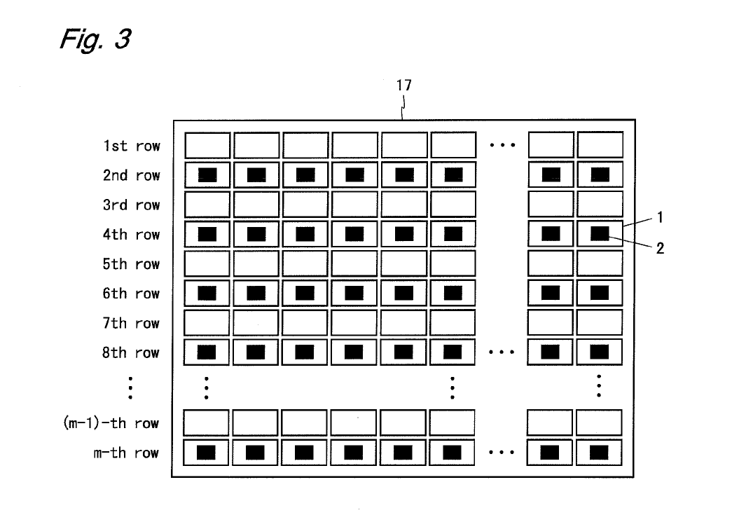

FIG. 3 is a diagram showing the arrangement position of the optical sensors 2 in the liquid crystal panel 11. As described above, the (m×n) pixels 1 and the (s×n) optical sensors 2 are arranged in the pixel array 17 of the liquid crystal panel 11. The number of the optical sensors 2 in the pixel array 17 is half the number of the pixels 1. As shown in FIG. 3, the optical sensors 2 are provided to be associated with all pixels 1 in even rows in the pixel array 17, on a one-to-one basis. As such, the optical sensors 2 are provided to be associated with pixels 1 in every other row. Also, all of the optical sensors 2 are provided to be associated with the pixels 1 in the even rows.

Referring back to FIG. 2, each optical sensor 2 includes a capacitor 23, a photodiode 24, and a sensor preamplifier 25. One electrode of the capacitor 23 is connected to a cathode terminal of the photodiode 24 (this connecting point is hereinafter referred to as a node P). The other electrode of the capacitor 23 is connected to a corresponding sensor read line RWt, and an anode terminal of the photodiode 24 is connected to a corresponding sensor reset line RSt. The sensor preamplifier 25 is configured by a TFT having a gate terminal connected to the node P and having a drain terminal connected to a corresponding B data signal line SBj and having a source terminal connected to a corresponding G data signal line SGj.

To detect the amount of light by an optical sensor 2 connected to a sensor read line RWt, a B data signal line SBj, etc., a predetermined voltage is applied to the sensor read line RWt and a sensor reset line RSt and a power supply voltage VDD is applied to the B data signal line SBj. When, after the predetermined voltage is applied to the sensor read line RWt and the sensor reset line RSt, light enters a photodiode 24, a current based on the amount of entered light flows through the photodiode 24 and accordingly the voltage at a node P decreases by an amount corresponding to the amount of current having flown through. By applying, at that timing, a high voltage to the sensor read line RWt to bring up the voltage at the node P and set the gate voltage of a sensor preamplifier 25 to a threshold value or more and then applying a power supply voltage VDD to the B data signal line SBj, the voltage at the node P is amplified by the sensor preamplifier 25 and the amplified voltage is outputted to a G data signal line SGj. Therefore, based on the voltage of the G data signal line SGj, the amount of light detected by the optical sensor 2 can be determined.

Around the pixel array 17 are provided a scanning signal line drive circuit 31, a data signal line drive circuit 32, a sensor row drive circuit 33, p sensor output amplifiers 34 (p is an integer between 1 and n inclusive), and a plurality of switches 35 to 38. The scanning signal line drive circuit 31, the data signal line drive circuit 32, and the sensor row drive circuit 33 correspond to the panel drive circuit 16 in FIG. 1. These circuits perform the operation of writing signals (voltage signals based on display data) into the pixel circuits 3 in the respective pixels 1 and the operation of reading signals (voltage signals based on the amounts of received light) from the respective optical sensors 2. At this time, the data signal line drive circuit 32 performs frame inversion/one-line inversion drive where the polarities of voltages written into the pixel circuits 3 are switched frame by frame and line by line. In one-line inversion drive, the polarities of voltages written into the pixel circuits 3 are switched between pixels 1 in the odd rows and pixels 1 in the even rows.

The data signal line drive circuit 32 has 3n output terminals for the respective 3n data signal lines. The switches 35 are provided between the G data signal lines SG1 to SGn and n output terminals provided for the respective G data signal lines SG1 to SGn, on a one-to-one basis. The switches 36 are provided between the B data signal lines SB1 to SBn and n output terminals provided for the respective B data signal lines SB1 to SBn, on a one-to-one basis. The G data signal lines SG1 to SGn are divided into groups, each including p G data signal lines. One switch 37 is provided between a k-th G data signal line in each group (k is an integer between 1 and p inclusive) and an input terminal of a k-th sensor output amplifier 34. One switch 38 is provided between each of the B data signal lines SB1 to SBn and a power supply voltage VDD. The respective numbers of the switches 35 to 38 included in FIG. 2 are all n.

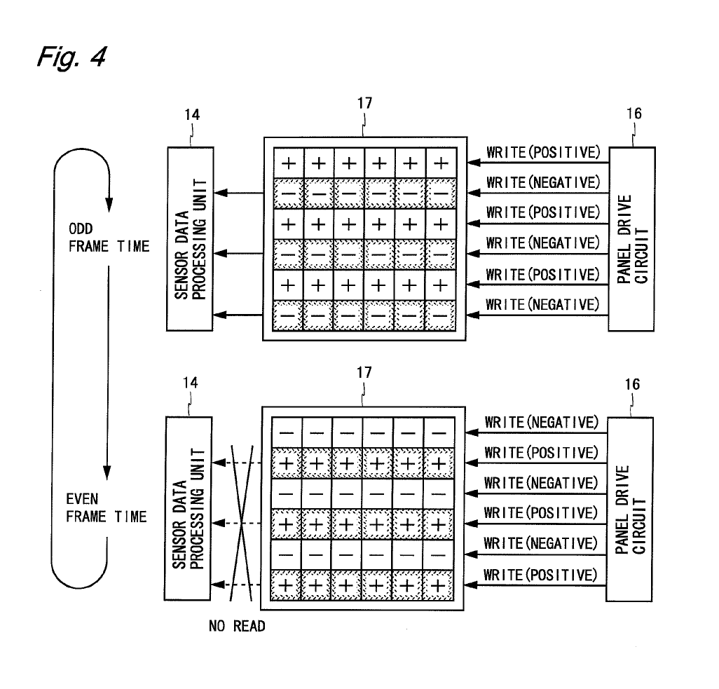

FIG. 4 is a diagram showing the operations of the liquid crystal display device 10. In FIG. 4, rectangles depicted in the pixel array 17 represent the pixels 1, and hatched rectangles represent pixels 1 in the even rows (pixels 1 having associated optical sensors 2). Characters provided in the rectangles represent the polarities of voltages written into the pixel circuits 3 in the respective pixels 1.

The panel drive circuit 16 performs different operations depending on an odd frame time or an even frame time. During the odd frame time, the panel drive circuit 16 writes positive voltages into pixel circuits 3 in respective pixels 1 in the odd rows, and writes negative voltages into pixel circuits 3 in respective pixels 1 in the even rows. During the odd frame time, the panel drive circuit 16 also performs a read from the optical sensors 2 in the pixel array 17. Since the optical sensors 2 are provided to be associated with pixels 1 in every other row, the panel drive circuit 16 performs a read from the optical sensors 2 associated with the pixels 1 in every other row.

During the even frame time, the panel drive circuit 16 writes negative voltages into the pixel circuits 3 in the respective pixels 1 in the odd rows, and writes positive voltages into the pixel circuits 3 in the respective pixels 1 in the even rows. During the even frame time, the panel drive circuit 16 does not perform a read from the optical sensors 2 in the pixel array 17.

When a write is performed, the switches 35 and 36 are placed in an on state and the switches 37 and 38 are placed in an off state, whereby the scanning signal line drive circuit 31 and the data signal line drive circuit 32 operate. The scanning signal line drive circuit 31 selects, every line time, one scanning signal line from among the scanning signal lines G1 to Gm, according to a timing control signal C1 and applies a high-level voltage to the selected scanning signal line and applies a low-level voltage to the other scanning signal lines. The data signal line drive circuit 32 drives the data signal lines SR1 to SRn, SG1 to SGn, and SB1 to SBn by a line sequential system, based on display data DR, DG, and DB outputted from the display data processing unit 12. More specifically, the data signal line drive circuit 32 stores at least a portion of each of the display data DR, DG, and DB for one row and applies, every line time, voltages based on the portions of the display data for one row to the data signal lines SR1 to SRn, SG1 to SGn, and SB1 to SBn. Note that the data signal line drive circuit 32 may drive the data signal lines SR1 to SRn, SG1 to SGn, and SB1 to SBn by a dot sequential system.

When a read is performed, the switches 35 and 36 are placed in an off state, the switches 38 are placed in an on state, and the switches 37 are placed in an on state in a time-division manner such that the G data signal lines SG1 to SGn are connected in turn to the input terminals of the sensor output amplifiers 34 on a group-by-group basis, whereby the sensor row drive circuit 33 and the sensor output amplifiers 34 operate. The sensor row drive circuit 33 selects, every line time, one each from the sensor read lines RWt and the sensor reset lines RSt, according to a timing control signal C2 and applies a predetermined read voltage and a predetermined reset voltage to the selected sensor read line and the selected sensor reset line, respectively, and applies a voltage different than those applied upon selection, to the other signal lines. The sensor output amplifiers 34 amplify voltages selected by their corresponding switches 37 and output the amplified voltages as sensor output signals SS1 to SSp.

FIG. 5 is a timing chart for the liquid crystal display device 10. As shown in FIG. 5, a vertical synchronizing signal VSYNC goes to a high level every frame time. During the odd frame time, in the first half part of each line time, the voltage of a scanning signal line Gi goes to a high level, the switches 35 and 36 are placed in an on state, and voltages to be written into 3n pixel circuits 3 connected to the scanning signal line Gi are applied to the data signal lines SR1 to SRn, SG1 to SGn, and SB1 to SBn. In addition, during the odd frame time, in the second half part of each even line time, the switches 38 are placed in an on state and the switches 37 are placed in an on state in a time-division manner. Hence, a power supply voltage VDD is fixedly applied to the B data signal lines SB1 to SBn, and the G data signal lines SG1 to SGn are connected to the input terminals of the sensor output amplifiers 34 in a time-division manner.

During the even frame time, as with the odd frame time, in the first half part of each line time, the voltage of the scanning signal line Gi goes to a high level, the switches 35 and 36 are placed in an on state, and voltages to be written into the 3n pixel circuits 3 connected to the scanning signal line Gi are applied to the data signal lines SR1 to SRn, SG1 to SGn, and SB1 to SBn. Meanwhile, during the even frame time, a read from the optical sensors 3 is not performed.

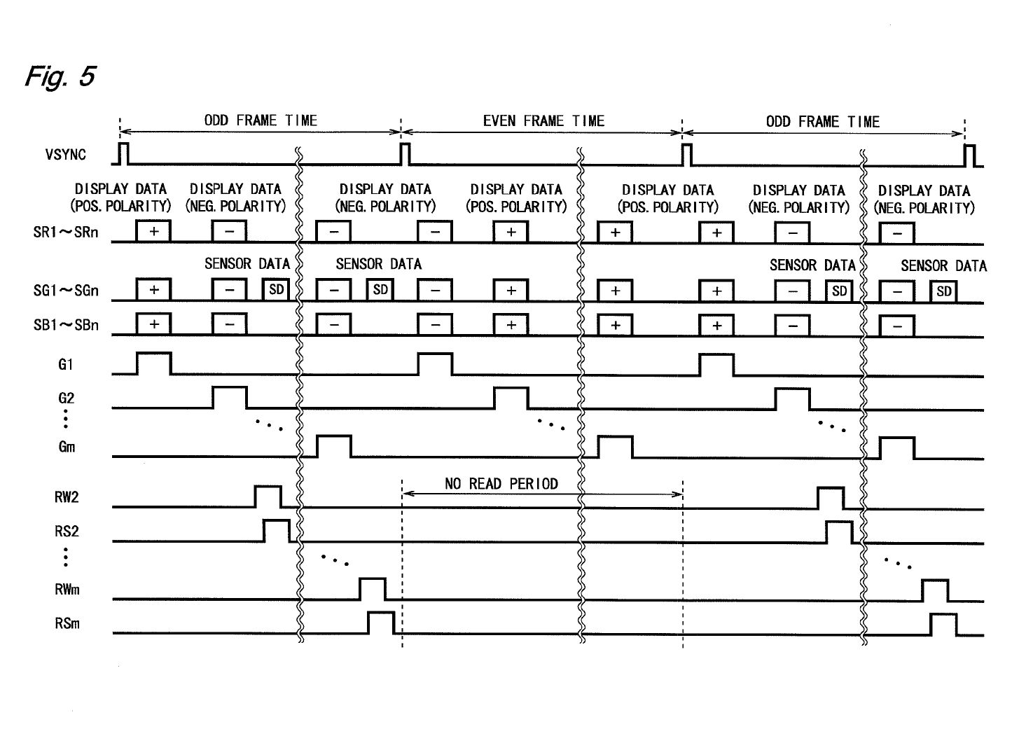

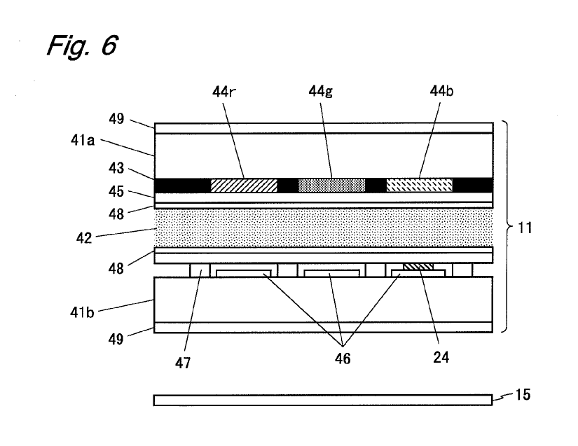

FIG. 6 is a diagram showing a cross section of the liquid crystal panel 11 and the arrangement position of the backlight 15. The liquid crystal panel 11 has a structure in which a liquid crystal layer 42 is sandwiched between two glass substrates 41a and 41b. One glass substrate 41a has a light-shielding film 43, color filters 44r, 44g, and 44b of three colors, a counter electrode 45, etc., provided thereon. The other glass substrate 41b has pixel electrodes 46, data signal lines 47, optical sensors 2, etc., provided thereon. Alignment films 48 are respectively provided on surfaces of the glass substrates 41a and 41b that face each other, and polarizing plates 49 are respectively provided on the other surfaces. Of the two surfaces of the liquid crystal panel 11, a surface on the side of the glass substrate 41a serves as the front surface and a surface on the side of the glass substrate 41b serves as the back surface. The backlight 15 is provided on the back surface side of the liquid crystal panel 11. In the example shown in FIG. 6, a photodiode 24 included in an optical sensor 2 is provided near a pixel electrode 46 where a blue color filter 44b is provided.

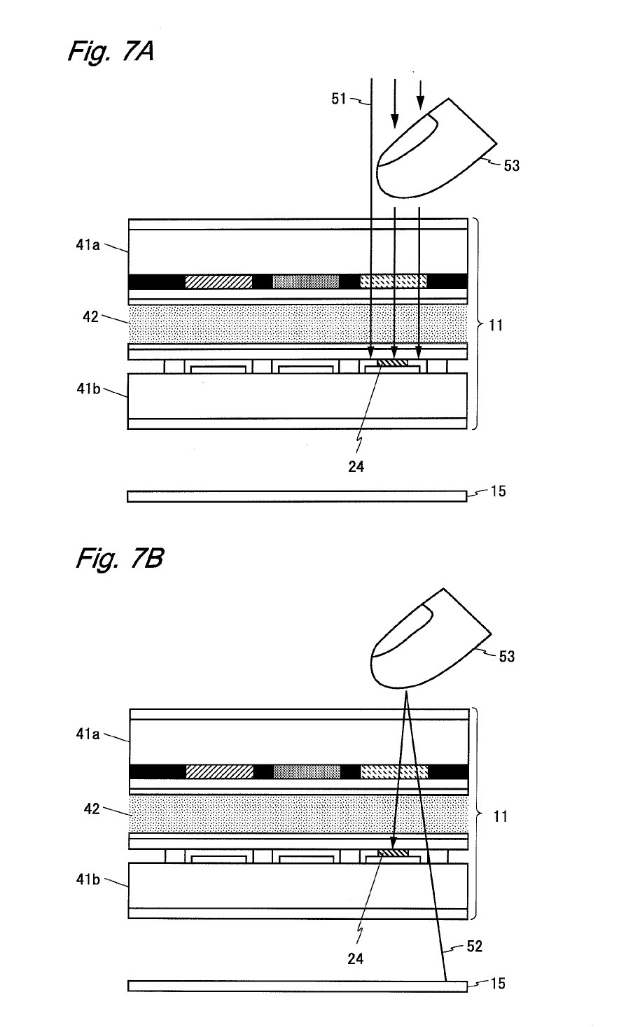

When the liquid crystal display device 10 detects a touch position on a display screen, the liquid crystal display device 10 uses either one of a method of detecting a shadow image and a method of detecting a reflection image (or both a shadow image and a reflection image). FIG. 7A is a diagram showing the principle of the method of detecting a shadow image, and FIG. 7B is a diagram showing the principle of the method of detecting a reflection image. In the method of detecting a shadow image (FIG. 7A), an optical sensor 2 including a photodiode 24 detects outside light 51 having passed through the glass substrate 41a, the liquid crystal layer 42, etc. At this time, if an object 53 such as a finger is present in the vicinity of the front surface of the liquid crystal panel 11, the outside light 51 to enter the optical sensor 2 is blocked by the object 53. Thus, with use of the optical sensor 2, a shadow image of the object 53 created by the outside light 51 can be detected.

In the method of detecting a reflection image (FIG. 7B), an optical sensor 2 including a photodiode 24 detects reflected light of backlight light 52. More specifically, the backlight light 52 emitted from the backlight 15 passes through and gets out of the liquid crystal panel 11 through the front surface of the liquid crystal panel 11. At this time, if an object 53 is present in the vicinity of the front surface of the liquid crystal panel 11, the backlight light 52 is reflected off the object 53. For example, the balls of human fingers reflect light well. The reflected light of the backlight light 52 passes through the glass substrate 41a, the liquid crystal layer 42, etc., and enters the optical sensor 2. Thus, using the optical sensor 2, a reflection image of the object 53 created by the backlight light 52 can be detected.

In addition, by using the above-described two methods in combination, both a shadow image and a reflection image can be detected. That is, with use of the optical sensor 2, a shadow image of the object 53 created by the outside light 51 and a reflection image of the object 53 created by the backlight light 52 can be simultaneously detected.

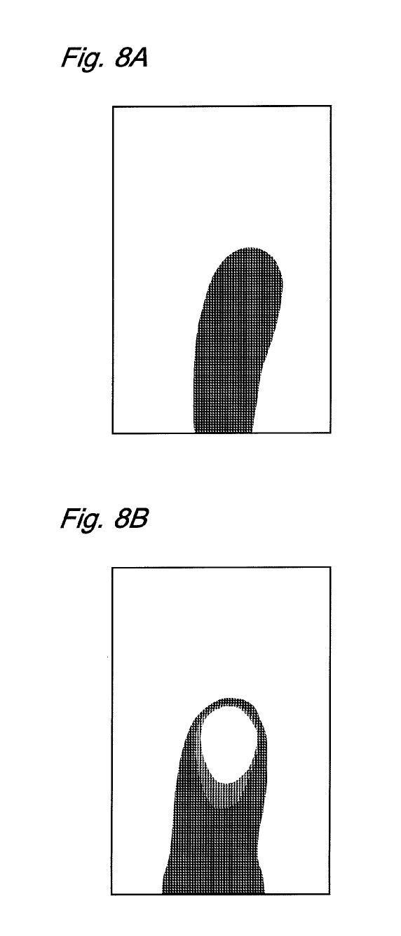

FIGS. 8A and 8B are diagrams showing the examples of a scanned image including a finger image. A scanned image shown in FIG. 8A includes a shadow image of a finger, and a scanned image shown in FIG. 8B includes a shadow image of a finger and a reflection image of the ball of the finger. The sensor data processing unit 14 performs an image recognition process on such scanned images and outputs coordinate data Co representing a touch position or outputs the scanned images as they are, external to the liquid crystal display device 10.

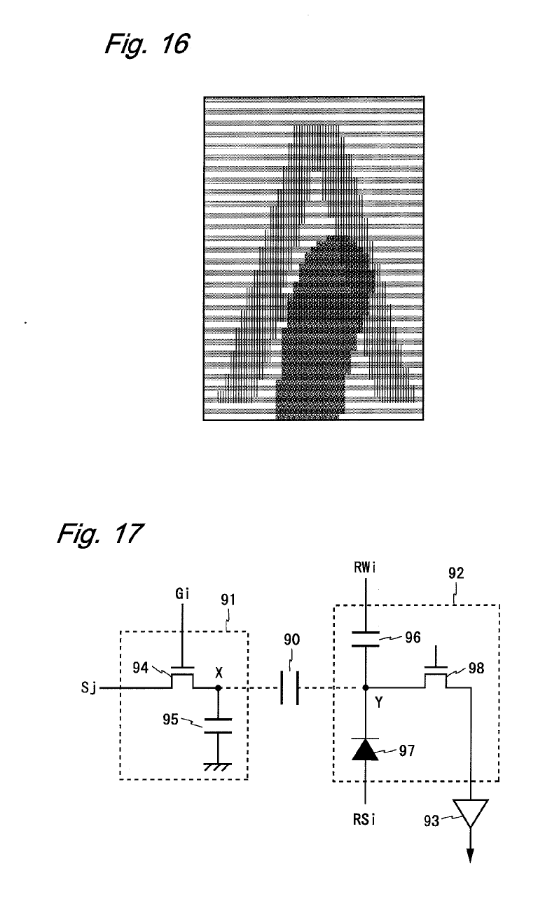

The effects of the liquid crystal display device 10 according to the present embodiment will be described below. As described with reference to FIGS. 16 and 17, a conventional liquid crystal display device having optical sensors that performs one-line inversion drive has a problem that stripe noise occurs in a scanned image due to the influence of the polarity of voltages written into pixel circuits.

On the other hand, in the liquid crystal display device 10 according to the present embodiment, the optical sensors 2 are provided to be associated with pixels 1 in the even rows, and the data signal line drive circuit 32 performs one-line inversion drive. In addition, a read from the optical sensors 2 is performed in the second half part of the even line time during the odd frame time, and in the immediately preceding first half part of the even line time negative voltages are written into pixel circuits 3 in the respective pixels 1 in the even rows.

As such, in the liquid crystal display device 10, after voltages of the same polarity (here, negative voltages) are written into pixel circuits 3 in the respective pixels 1 in the even rows, signals based on the amounts of received light are read from the optical sensors 2 associated with the pixels 1 in the even rows. Thus, the outputs from the optical sensors 2 change in the same direction due to the influence of display data (here, the outputs decrease). Therefore, according to the liquid crystal display device 10 according to the present embodiment, stripe noise resulting from the switching of the polarities of voltages written into the pixel circuits 3 can be prevented from occurring in a scanned image generated based on the outputs from the optical sensors 2. Accordingly, a touch position can be detected with high accuracy based on a scanned image, and an image with suppressed noise can be inputted. In addition, by providing the optical sensors 2 to be associated with some pixels 1, the amount of circuitry of the liquid crystal display device 10 can be reduced.

In addition, according to the liquid crystal display device 10, in a liquid crystal display device that performs one-line inversion drive, a scanned image not containing stripe noise with a width of one line can be obtained. In addition, by providing the optical sensors 2 to be associated with all pixels 1 in the even rows, a scanned image whose number of pixels in the row direction is the same as that of the liquid crystal panel 11 and which does not contain stripe noise can be obtained. In addition, by providing all of the optical sensors 2 to be associated with pixels 1 in the even rows, a scanned image which is generated based on the outputs from all of the optical sensors 2 and which does not contain stripe noise can be obtained.

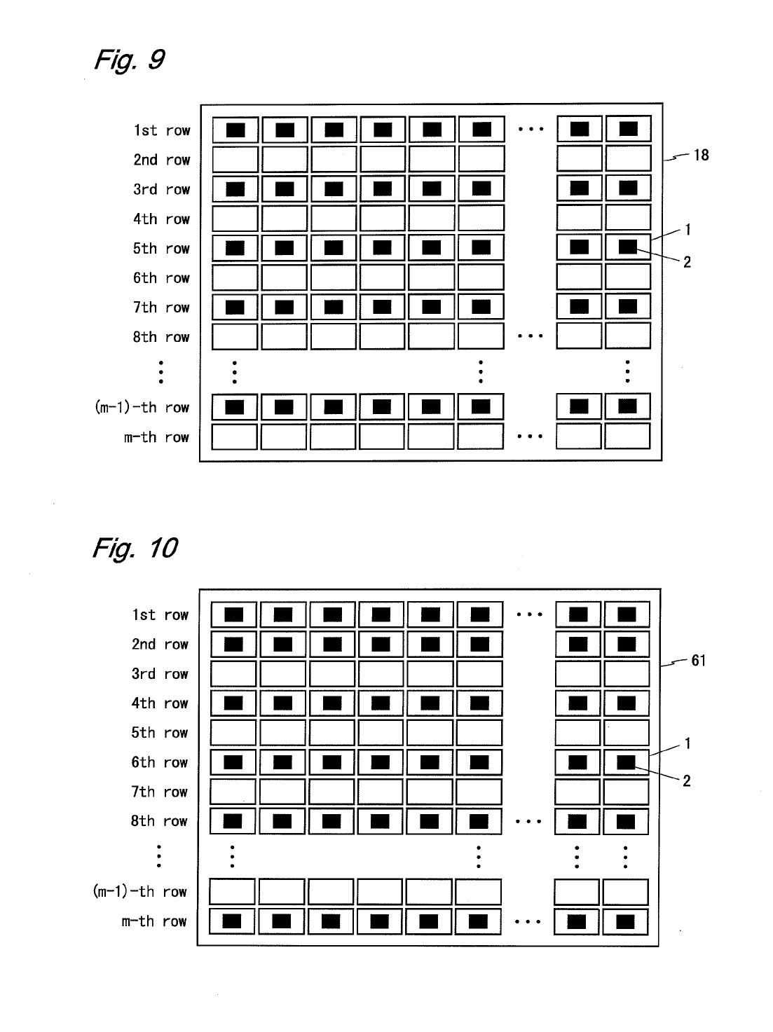

Note that although, in the pixel array 17 shown in FIG. 3, the optical sensors 2 are provided to be associated with all pixels 1 in the even rows, instead of this, as in a pixel array 18 shown in FIG. 9, optical sensors 2 may be provided to be associated with all pixels 1 in the odd rows. In this case, in the liquid crystal panel, sensor read lines and sensor reset lines according to the arrangement position of the optical sensors 2 are provided. A liquid crystal display device having a liquid crystal panel including the pixel array 18 operates in the same manner as the liquid crystal display device 10 and provides the same effects as those provided by the liquid crystal display device 10.

### Second Embodiment

A liquid crystal display device according to a second embodiment of the present invention has the same configuration as a liquid crystal display device 10 according to the first embodiment, and operates in the same manner as the liquid crystal display device 10. In the liquid crystal display device according to the present embodiment, the arrangement position of optical sensors 2 is different from that in the liquid crystal display device 10, and sensor read lines and sensor reset lines according to the arrangement position of the optical sensors 2 are provided in a liquid crystal panel. For the arrangement position of the optical sensors 2 in the liquid crystal panel included in the liquid crystal display device according to the present embodiment, first to sixth examples will be described below.

FIG. 10 is a diagram showing a first example of the arrangement position of the optical sensors 2. In the example shown in FIG. 10, optical sensors 2 are provided to be associated with all pixels 1 in the first row and even rows in a pixel array 61. In a liquid crystal display device having a liquid crystal panel including the pixel array 61, frame inversion/one-line inversion drive is performed. In addition, a read from the optical sensors 2 is performed on those optical sensors 2 associated with pixels 1 in the even rows. Thus, a sensor read line and a sensor reset line do not need to be provided for those optical sensors 2 associated with the pixels 1 in the first row.

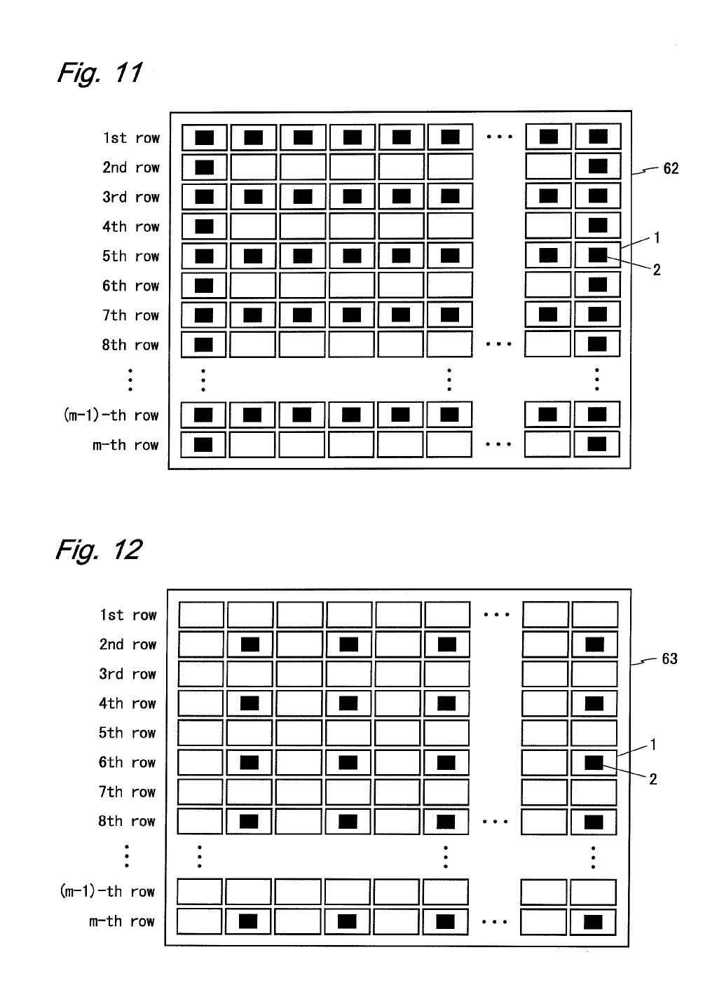

FIG. 11 is a diagram showing a second example of the arrangement position of the optical sensors 2. In the example shown in FIG. 11, optical sensors 2 are provided to be associated with all pixels 1 in odd rows and pixels 1 at both ends of the even rows in a pixel array 62. In a liquid crystal display device having a liquid crystal panel including the pixel array 62, frame inversion/one-line inversion drive is performed. In addition, a read from the optical sensors 2 is performed on those optical sensors 2 associated with the pixels 1 in the odd rows. Thus, sensor read lines and sensor reset lines do not need to be provided for those optical sensors 2 associated with the pixels 1 in the even rows.

FIG. 12 is a diagram showing a third example of the arrangement position of the optical sensors 2. In the example shown in FIG. 12, optical sensors 2 are provided to be associated with even pixels 1 in the even rows in a pixel array 63. In a liquid crystal display device having a liquid crystal panel including the pixel array 63, frame inversion/one-line inversion drive is performed. In addition, a read from the optical sensors 2 is performed on the even pixels 1 in the even rows. Thus, sensor read lines and sensor reset lines do not need to be provided for those optical sensors 2 associated with the pixels 1 in the odd rows, and switches 37 and 38 do not need to be provided to odd green data signal lines SGj and odd blue data signal lines SBj.

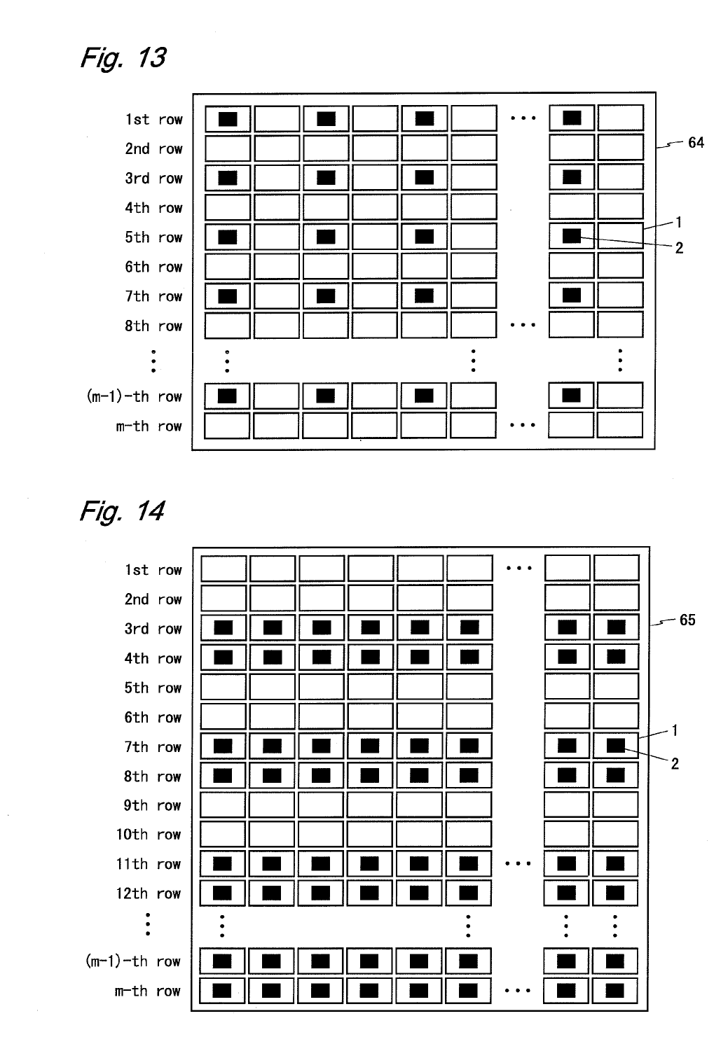

FIG. 13 is a diagram showing a fourth example of the arrangement position of the optical sensors 2. In the example shown in FIG. 13, optical sensors 2 are provided to be associated with odd pixels 1 in the odd rows in a pixel array 64. In a liquid crystal display device having a liquid crystal panel including the pixel array 64, frame inversion/one-line inversion drive is performed. In addition, a read from the optical sensors 2 is performed on the odd pixels 1 in the odd rows. Thus, sensor read lines and sensor reset lines do not need to be provided for those optical sensors 2 associated with the pixels 1 in the even rows, and switches 37 and 38 do not need to be provided to even green data signal lines SGj and even blue data signal lines SBj.

As shown in FIGS. 12 and 13, by providing the optical sensors 2 to be associated with every other pixel 1 in the row direction, the amount of circuitry of the liquid crystal display device can be reduced. Note that the optical sensors 2 may be provided at wider intervals between pixels 1 in each row. For example, optical sensors 2 may be provided to be associated with every third pixel in the row direction (i.e., at a ratio of one optical sensor to three pixels). By this, the amount of circuitry of the liquid crystal display device can be further reduced.

FIG. 14 is a diagram showing a fifth example of the arrangement position of the optical sensors 2. In the example shown in FIG. 14, optical sensors 2 are provided to be associated with all pixels 1 in the (4a-1)-th rows and the 4a-th rows in a pixel array 65 (a is an integer between 1 and m/4 inclusive). In a liquid crystal display device having a liquid crystal panel including the pixel array 65, a panel drive circuit performs frame inversion/two-line inversion drive where the polarities of voltages written into pixel circuits are switched frame by frame and two lines by two lines, and performs a read from the optical sensors 2 associated with the pixels 1 in every other two rows. Note that, in a liquid crystal display device that performs two-line inversion drive, optical sensors 2 may be provided to be associated with all pixels 1 in the (4a-3)-th rows and the (4a-2)-th rows in a pixel array.

In liquid crystal display devices having liquid crystal panels including the pixel arrays 61 and 63, voltages of the same polarity are written into pixel circuits in respective pixels 1 in the even rows. In liquid crystal display devices having liquid crystal panels including the pixel arrays 62 and 64, voltages of the same polarity are written into pixel circuits in respective pixels 1 in the odd rows. In a liquid crystal display device having a liquid crystal panel including the pixel array 65, voltages of the same polarity are written into pixel circuits in respective pixels 1 in the (4a-1)-th rows and the 4a-th rows. In all of these liquid crystal display devices, a read is performed from optical sensors 2 associated with pixels 1 including pixel circuits into which voltages of the same polarity are written. Therefore, according to these liquid crystal display devices, as with the liquid crystal display device 10 according to the first embodiment, stripe noise resulting from the switching of the polarities of voltages written into the pixel circuits can be prevented from occurring in a scanned image. In addition, the detection accuracy for a touch position can be increased, noise in an input image can be suppressed, and the amount of circuitry of the liquid crystal display devices can be reduced.

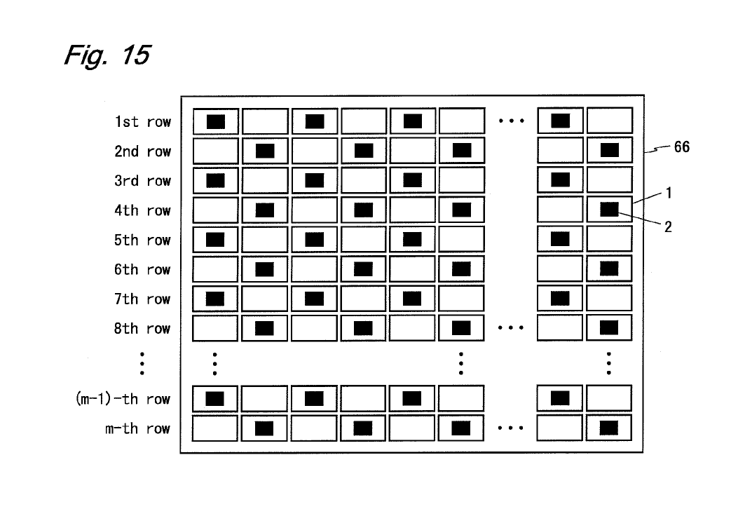

FIG. 15 is a diagram showing a sixth example of the arrangement position of the optical sensors 2. In the example shown in FIG. 15, when the positions of pixels 1 are divided into two groups in a checkered pattern, optical sensors 2 are provided to be associated with pixels in the positions of one group. Specifically, the optical sensors 2 are provided to be associated with odd pixels 1 in the odd rows and even row pixels 1 in the even rows in a pixel array 66. In a liquid crystal display device having a liquid crystal panel including the pixel array 66, frame inversion/dot inversion drive where the polarities of voltages written into pixel circuits are switched frame by frame, line by line, and pixel by pixel is performed. In addition, a read from the optical sensors 2 is performed on the odd pixels 1 in the odd rows and the even pixels 1 in the even rows.

In a liquid crystal display device having a liquid crystal panel including the pixel array 66, voltages of the same polarity are written into pixel circuits in respective odd pixels 1 in the odd rows and respective even pixels 1 in the even rows, and a read is performed from optical sensors 2 associated with the pixels 1 including the pixel circuits into which voltages of the same polarity are written. Therefore, according to the liquid crystal display device, as with the liquid crystal display device 10 according to the first embodiment, noise resulting from the switching of the polarities of voltages written into the pixel circuits can be prevented from occurring in a scanned image. In addition, the detection accuracy for a touch position can be increased, noise in an input image can be suppressed, and the amount of circuitry of the liquid crystal display device can be reduced.

In addition, by providing optical sensors 2 to be associated with all pixels 1 present in the same position as one of two colors of the checkered pattern, a scanned image whose number of pixels is half that of the liquid crystal panel and which does not contain noise resulting from the switching of the polarities of write voltages can be obtained. In addition, by providing all of the optical sensors 2 to be associated with the pixels 1 present in the same position as one of two colors of the checkered pattern, a scanned image which is generated based on the outputs from all of the optical sensors 2 and which does not contain noise resulting from the switching of the polarities of write voltages can be obtained.

Note that, for liquid crystal display devices according to the embodiments of the present invention, various variants with different arrangement positions of optical sensors 2 can be formed. In general, to configure a liquid crystal display device that performs q-line inversion drive for integer q greater than or equal to 1 (i.e., switches the polarities of voltages written into pixel circuits, every q lines), optical sensors are provided to be associated with pixels in every other q rows. More specifically, when the rows of pixels are divided every q rows into a first group and a second group according to the arrangement order, all or most of the optical sensors are provided to be associated with pixels in rows of the first group, and a panel drive circuit is provided that switches the polarities of voltages written into pixel circuits between the pixels in the rows of the first group and the pixels in the rows of the second group, and reads signals based on the amounts of received light, from those optical sensors associated with the pixels in the rows of the first group.

A new arrangement may be obtained by arbitrarily combining the characteristics of the arrangements of the optical sensors 2 described above without departing from their properties, and optical sensors 2 may be arranged in the obtained position. Alternatively, a pixel 1 that does not have an associated optical sensor 2 may be provided with an optical sensor configured such that light does not enter a light-receiving portion thereof (hereinafter, referred to as a light-shielding sensor). By providing light-shielding sensors in a liquid crystal panel in addition to optical sensors 2, and comparing, outside the liquid crystal panel, the outputs from the optical sensors 2 with the outputs from the light-shielding sensors, temperature compensation can be performed. In addition, display devices other than liquid crystal display devices can also be configured by the above-described methods. By display devices (including liquid crystal display devices) according to these variants, too, as with liquid crystal display devices according to the embodiments of the present invention, stripe noise resulting from the switching of the polarities of voltages written into pixel circuits can be prevented from occurring in a scanned image generated based on the outputs from optical sensors.

### INDUSTRIAL APPLICABILITY

Display devices having optical sensors of the present invention have a feature that they can prevent noise resulting from the switching of the polarities of write voltages from occurring in a scanned image, and thus, can be used as various display devices such as liquid crystal display devices.

1. A display device including a plurality of optical sensors, the display device comprising:
a display panel including a plurality of pixels and a plurality of optical sensors which are arranged side by side in a row direction and in a column direction; and
a drive circuit that performs an operation of writing voltages based on display data into pixel circuits in the respective pixels, and an operation of reading signals based on amounts of received light, from the optical sensors, wherein
when the pixels are divided into a first group and a second group by arrangement position, all or most of the optical sensors are provided to be associated with pixels of the first group, and
the drive circuit switches polarities of the voltages written into the pixel circuits between the pixels of the first group and the pixels of the second group, and reads the signals from the optical sensors associated with the pixels of the first group.

2. The display device according to claim 1, wherein
when rows of the pixels are divided into first rows and second rows every predetermined number of rows according to arrangement order, all or most of the optical sensors are provided to be associated with pixels in the first rows, and
the drive circuit switches the polarities of the voltages written into the pixel circuits between the pixels in the first rows and the pixels in the second rows, and reads the signals from the optical sensors associated with the pixels in the first rows.

3. The display device according to claim 2, wherein
all or most of the optical sensors are provided to be associated with the pixels in every other row, and
the drive circuit switches the polarities of the voltages written into the pixel circuits every row, and reads the signals from the optical sensors associated with the pixels in every other row.

4. The display device according to claim 2, wherein the optical sensors are provided to be associated with all of the pixels in the first rows.

5. The display device according to claim 2, wherein the optical sensors are provided to be associated with pixels with an interval of a predetermined number of pixels in the row direction, among the pixels in the first rows.

6. The display device according to claim 2, wherein all of the optical sensors are provided to be associated with the pixels in the first rows.

7. The display device according to claim 1, wherein
when positions of the pixels are divided into first positions and second positions in a checkered pattern, all or most of the optical sensors are provided to be associated with pixels in the first positions, and
the drive circuit switches the polarities of the voltages written into the pixel circuits between the pixels in the first positions and the pixels in the second positions, and reads the signals from the optical sensors associated with the pixels in the first positions.

8. The display device according to claim 7, wherein the optical sensors are provided to be associated with all of the pixels in the first positions.

9. The display device according to claim 7, wherein all of the optical sensors are provided to be associated with the pixels in the first positions.

10. A method of driving a display device having a display panel including a plurality of pixels and a plurality of optical sensors which are arranged side by side in a row direction and in a column direction; and a drive circuit that drives the display panel, wherein, when the pixels are divided into a first group and a second group by arrangement position, all or most of the optical sensors are provided to be associated with pixels of the first group, the method comprising the steps of:
by using the drive circuit, writing voltages based on display data into pixel circuits in the respective pixels while switching polarities of the voltages between the pixels of the first group and the pixels of the second group; and
by using the drive circuit, reading signals based on amounts of received light, from the optical sensors associated with the pixels of the first group.
